(19) United States
(12) Patent Application Publication
(10) Pub. No.: US 2016/0218588 A1
(43) Pub. Date: Jul. 28, 2016

(54) MOTOR VIBRATION DEVICE

(71) Applicant: JOHNSON ELECTRIC S.A., MURTEN (CH)

(72) Inventors: Shi Liang Long, Shenzhen (CN); Da Quan Zhang, Shenzhen (CN)

(21) Appl. No.: 15/003,155

(22) Filed: Jan. 21, 2016

(30) Foreign Application Priority Data
Jan. 23, 2015 (CN) 201510036916.7

(51) Int. Cl. H02K 7/075

(52) U.S. Cl. CPC H02K 7/075

(57) ABSTRACT

A motor vibration device includes a motor having a rotating shaft and an eccentric fixed to the shaft. The eccentric includes multiple stacked eccentric plates fixed together by engaging mounting protrusions and mounting recesses formed on adjacent eccentric plates. Each eccentric plate includes a connection portion and an eccentric portion connected to the connection portion. The connection portion has a through hole into which the shaft is pressed. The eccentric portion includes a first straight edge and a second straight edge respectively extending from two sides of the connection portion, and a circular arc edge connecting the first and second straight edges. An included angle between the first and second straight edges ranges from 150 degrees to 180 degrees.

### CROSS REFERENCE TO RELATED APPLICATIONS

This non-provisional patent application claims priority under 35 U.S.C. §119(a) from Patent Application No. 201510036916.7 filed in The People's Republic of China on Jan. 23, 2015, the entire contents of which are hereby incorporated by reference.

### FIELD OF THE INVENTION

This invention relates to a motor vibration device and in particular, to an eccentric of the motor vibration device.

### BACKGROUND OF THE INVENTION

A vibration motor or motor vibration device is used in a tactile warning device to give a strong vibration used to alert a user. An eccentric, being a rotating mass having an axis of rotation offset from a center of mass, used in a conventional vibration motor is generally made of a single piece of copper, which is difficult to manufacture and has a high cost and accordingly, the vibration motor has a high cost.

### SUMMARY OF THE INVENTION

Hence there is a desire for a motor vibration device having a low cost eccentric.

Accordingly, in one aspect thereof, the present invention provides a motor vibration device, comprising a motor having a rotating shaft, and an eccentric fixed to the shaft, wherein the eccentric comprises a plurality of stacked eccentric plates fixed together by engagement of mounting protrusions and mounting recesses formed on adjacent eccentric plates, each of the eccentric plates comprises a connection portion fixed to the shaft and an eccentric portion extending from the connection portion, the connection portion is provided with a through hole for insertion of the shaft, the eccentric portion comprises a first straight edge and a second straight edge respectively extending from two sides of the connection portion and a circular arc edge connecting the first straight edge and the second straight edge, and an included angle between the first straight edge and the second straight edge ranges from 150 degrees to 180 degrees.

Preferably, in two adjacent eccentric plates, one of the two adjacent eccentric plates has two mounting recesses, and the other one of the two adjacent eccentric plates has two mounting protrusion, and the mounting recesses and the mounting protrusions are configured to fit tightly to fix the two adjacent eccentric plates together.

Preferably, each of the eccentric plates is stamped to form the mounting recesses on one side and the mounting protrusions on the other side at positions corresponding to the mounting recesses.

Preferably, each mounting protrusion extends from the respective eccentric portion in a direction perpendicular to the eccentric portion.

Preferably, each mounting protrusion is approximately in a shape of a truncated pyramid, and comprises a first lateral surface and a second lateral surface perpendicular to the eccentric portion, and the first lateral surface and the second lateral surface are configured to fit tightly with the respective mounting recess.

Preferably, an outermost eccentric plate of the eccentric does not have a mounting protrusion.

Preferably, each mounting recess has an opening in a shape of a rectangle, and a longitudinal axis of the opening coincides with a radial direction of the circular arc edge.

Preferably, an included angle between the two mounting recesses with respect to a center of the through hole is in the range from 90 degrees to 180 degrees.

Preferably, an included angle between the two mounting recesses with respect to a center of the through hole ranges from 105 degrees to 165 degrees.

Preferably, an included angle between the two mounting recesses with respect to the center of the through hole is 120 degree.

Preferably, each mounting protrusion has an extending height that is less than a thickness of the eccentric plate.

Preferably, the included angle between the first straight edge and the second straight edge ranges from 160 degrees to 180 degrees.

Preferably, a center of the through hole of the connection portion coincides with a center of the circular arc edge.

Preferably, each mounting protrusion has a cylindrical shape or semi-spherical shape.

Preferably, a ratio of the radius of the mounting protrusion to the radius of the circular arc edge ranges from 5% to 35%.

Preferably, a ratio of the radius of the mounting protrusion to the radius of the circular arc edge is in the range of 15% to 20%.

According to a second aspect, the present invention provides a motor vibration device, comprising: a motor having a rotating shaft; and an eccentric fixed to the shaft, the eccentric comprising a plurality of stacked eccentric plates, each of the eccentric plates having a connection portion fixed to the shaft and an eccentric portion extending from the connection portion, the connection portion having a through hole through which the shaft extends, wherein the plurality of eccentric plates are fixed together by engaging mounting protrusions and mounting recesses formed on adjacent eccentric plates, each eccentric plate has two mounting recesses, and the included angle between the two mounting recesses with respect to the center of the through hole of the connection portion ranges is in the range of 90 degrees to 180 degrees.

Preferably, the included angle between the two mounting recesses with respect to a center of the through hole is in the range of 105 degrees to 165 degrees.

Preferably, the included angle between the two mounting recesses with respect to the center of the through hole is 120 degrees.

Preferably, the mounting protrusion has a cylindrical shape or semi-spherical shape.

In the motor vibration device according to the present invention, the eccentric is formed by stacking several eccentric plates, thereby reducing the cost.

### BRIEF DESCRIPTION OF THE DRAWINGS

Preferred embodiments of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1 illustrates a motor vibration device according to a preferred embodiment of the present invention:

FIG. 2 illustrates an eccentric of the motor vibration device of FIG. 1:

FIG. 3 illustrates an eccentric plate of the eccentric of FIG. 2 from a first perspective;

FIG. 4 illustrates the eccentric plate from a second perspective;

FIG. 5 is a sectional view of the eccentric, showing a nesting relationship between the eccentric plates:

FIG. 6 illustrates the eccentric plate of FIG. 4 from another angle:

FIG. 7 shows an eccentric of a motor vibration device according to another embodiment;

FIG. 8 shows an eccentric plate of the eccentric of FIG. 7; and

FIG. 9 is a plan view of the eccentric plate of FIG. 8.

### DETAILED DESCRIPTION OF THE PREFERRED EMBODIMENTS

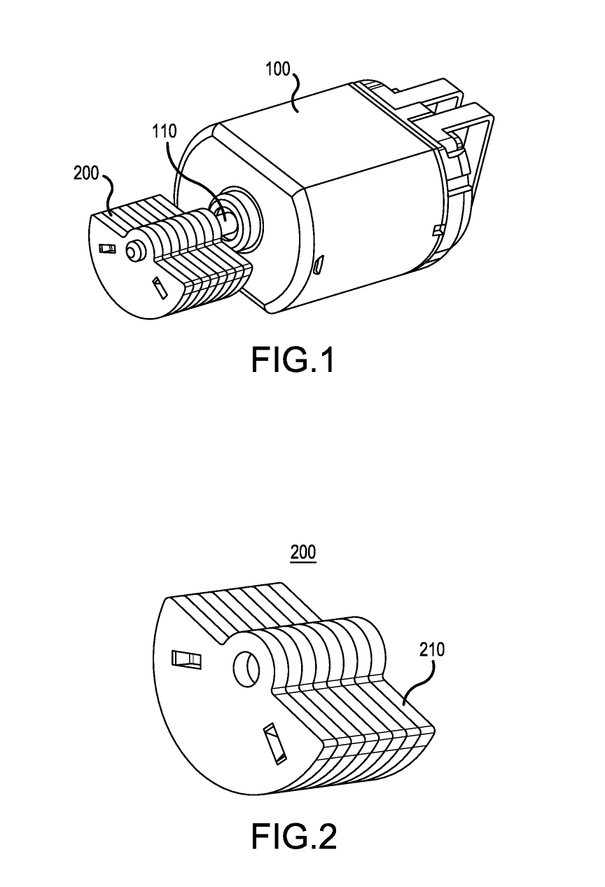

Referring firstly to FIG. 1, a motor vibration device according to an embodiment of the present invention includes a motor 100 and an eccentric 200. The motor 100 includes a stator and a rotor rotatably installed on the stator, and the rotor includes a rotating shaft 110. The eccentric 200 is fixedly mounted on the shaft 110. When the motor is operating, the shaft 110 rotates the eccentric 200, thereby generating a vibration.

Referring to FIG. 2, the eccentric 200 includes several stacked eccentric plates 210 which have substantially the same shape and are fixed together.

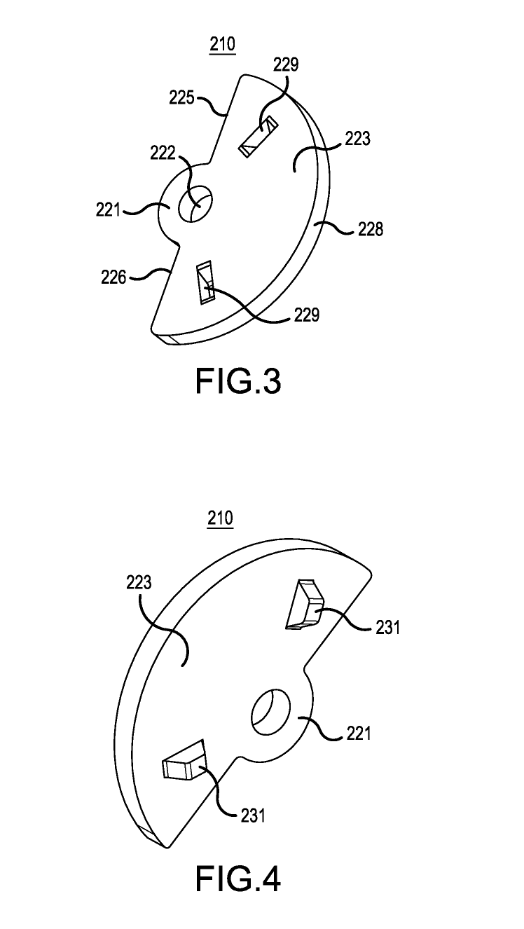

Referring to FIG. 3, the eccentric plate 210 includes a connection portion 221 and an eccentric portion 223 which are formed integrally, and the connection portion 221 has a through hole 222 for fixing the eccentric to the shaft of the motor. Preferably, the shaft is a press fit in the through hole. The eccentric portion 223 is approximately in a shape of a sector and includes a first straight edge 225 and a second straight edge 226 which extend from the connection portion 221, and a circular arc edge 228 connected to an end of the first straight edge 225 and an end of the second straight edge 226. An outer contour of the connection portion 221 is in a shape of a circular arc edge, to reduce rotational resistance. In this embodiment, an included angle between the first straight edge 225 and the second straight edge 226 is 180 degrees, and the center of the through hole 222 of the connection portion 221 coincides with the center of the circular arc edge 228. In alternative solutions, the included angle between the first straight edge 225 and the second straight edge 226 ranges from 150 degrees to 180 degrees, or preferably ranges from 160 degrees to 180 degrees.

With reference to FIGS. 3 through 5, the eccentric plates 210 are stacked and fixed together by engagement of mounting protrusions 231 and mounting recesses 229 formed on adjacent eccentric plates 210. In this embodiment, each eccentric plate 210 is stamped to form a mounting recess 229 on one side of the eccentric portion 223 and to form a mounting protrusion 231 on the other side of the eccentric portion 223 at a position corresponding to the mounting recess 229. In this way, when the eccentric plates 210 are stacked together, the mounting protrusion 231 cooperates with the mounting recess 229 to fix the two adjacent eccentric plates 210 together.

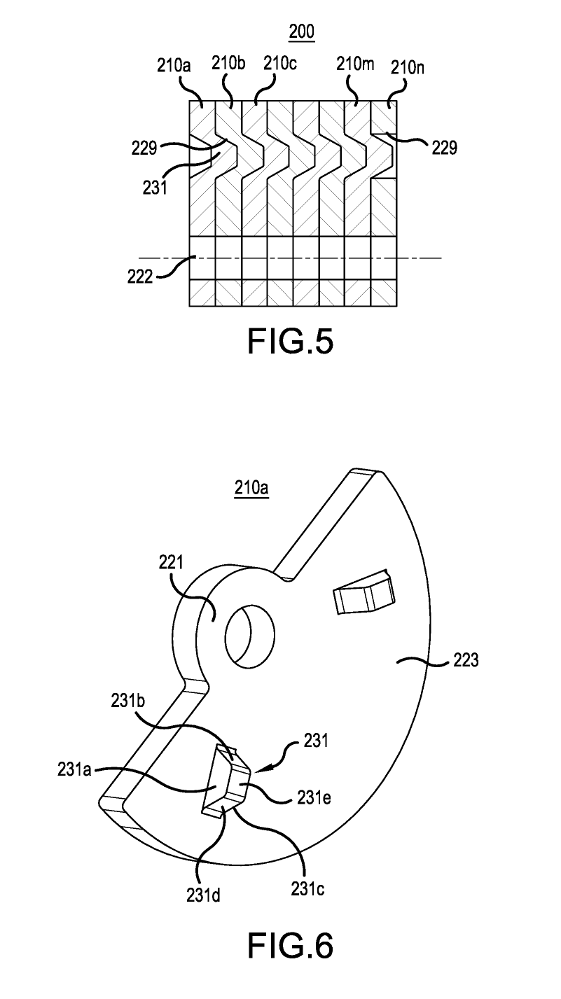

Referring to FIG. 5, in a process of stacking two adjacent eccentric plates (adjacent eccentric plates 210a and 210b are taken as an example for ease of description), a mounting protrusion 231 of the eccentric plate 210a is inserted into a mounting recess 229 of the eccentric plate 210b. Preferably, the mounting protrusion 231 is fixed tightly into the mounting recess 229, i.e. as a press fit, thereby positioning and fixing the eccentric plate 210a with the eccentric plate 210b. An eccentric 200 is formed by stacking several eccentric plates, such as eccentric plates 210a, 210b, 210c . . . 210m and 210n, in the above way. In this embodiment, an outermost eccentric plate 210n of the eccentric 200 does not have a mounting protrusion 229 and is stamped to form mounting recesses 229 in the form of through holes, penetrating the eccentric plate 210n, thereby reducing a resistance on the eccentric 200 when the eccentric 200 rotates. In an alternative solution, the outermost eccentric plate of the eccentric may also have the mounting protrusion, and in this case, all mounting protrusions have the same shape and can be formed by a same forming machine.

The structure of the mounting protrusion 231 of this embodiment is further described hereinafter with reference to FIG. 6 by taking the eccentric plate 210a as an example. The mounting protrusion 231 generally extends from the eccentric portion 223 in a direction perpendicular to the eccentric portion 223, and includes a first lateral surface 231a and a second lateral surface 231c which are perpendicular to the eccentric portion 223. In the assembly process, the first lateral surface 231a and the second lateral surface 231c fit tightly with side walls of the mounting recess 229 of an adjacent eccentric plate, such as the eccentric plate 210b shown in FIG. 5. In this embodiment, the mounting protrusion 231 is approximately in a shape of a truncated pyramid, and another two lateral surfaces 231b and 231d of the mounting protrusion 231 are inclined with respect to the eccentric portion 223 to form a closing trend, thereby allowing the mounting protrusion 231 to have a structure having a narrow top 231e and a wide bottom, and facilitating inserting the mounting protrusion 231 into the mounting recess of the adjacent eccentric plate. A distance between the top 231e of the mounting protrusion 231 and the eccentric portion 223 defines a height of the mounting protrusion 231, and the height of the mounting protrusion 231 is smaller than a thickness of the eccentric portion 223. In another aspect, in this embodiment, the mounting protrusion 231 is approximate to a prism, the first lateral surface 231a and the second lateral surface 231c which are parallel to each other are two parallel end surfaces of the prism, and a cross section of the prism is approximate to a trapezoid.

In this embodiment, the thickness of the eccentric plate 210 is in a range from 1.16 mm to 1.24 mm inclusively, a total thickness of the eccentric 200 is 9.6 mm, and the eccentric 200 includes eight pieces of the eccentric plates 210. A radius of the eccentric portion 223 is 7.3 mm, a diameter of the through hole of the connection portion 221 is 2 mm, and an outer edge of the connection portion 221 is a circular arc. An opening of the mounting recess 229 formed by stamping is in a shape of a rectangle, and a longitudinal axis of the opening approximately coincides with a radial direction of the circular arc edge of the eccentric portion. A connecting line between the center of the mounting recess and the center of the connection portion forms an included angle of about 30 degrees with respect to the adjacent straight edge (such as the straight edge 225 or 226). In alternative solutions, the included angle between the mounting recess 229 and the adjacent straight edge ranges from 0 degree to 40 degrees. The included angle between the two mounting recess 229 with respect to the center of the mounting hole 222, i.e., the included angle between two connecting lines each of which passing through a respective center of the mounting recess and the center of the connection portion, ranges from 90 degrees to 180 degrees, and preferably ranges from 105 degrees to 165 degrees. In the present embodiment, the included angle is 120 degrees.

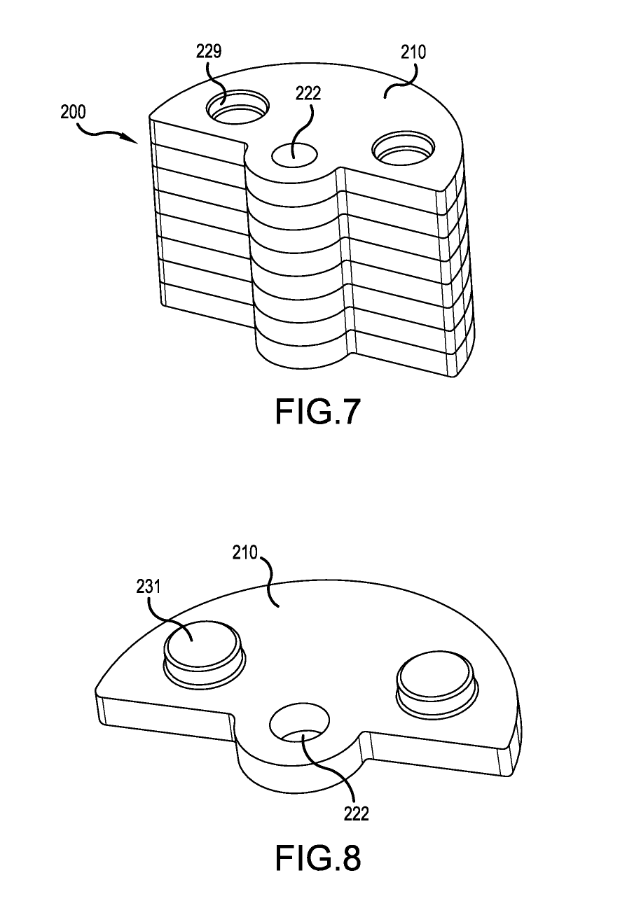

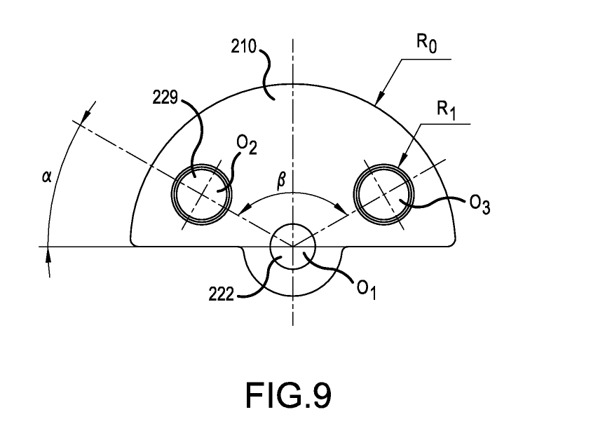

FIG. 7 shows an eccentric 200 according to another embodiment, showing the mounting recesses 229 having a different shape. Referring also to FIGS. 8 and 9, in this present embodiment, the mounting recess 229 has a circular shape, and correspondingly the mounting protrusion 231 has a cylindrical shape. In an alternative embodiment, the mounting protrusions can also be semi-spherical in shape. The ratio of the radius of the mounting protrusion R₁ to the radius of the circular arc edge of the eccentric plate 210 R₀ ranges from 5% to 35%, and preferably ranges from 15% to 25%. In this embodiment, the radius of the mounting protrusion R₁ is 1.25 mm, the radius of the circular arc edge of the eccentric portion R₀ is 7.3 mm, and the ratio is about 17.1%.

In this embodiment, the included angle between the mounting recess 229 and the adjacent straight edge a is 30 degrees, and it can range from 0 degree to 40 degrees. The included angle β between the two mounting recesses 229 is 120 degrees. In alternative embodiments, the included angle ranges from 90 degrees to 180 degrees and preferably ranges from 105 degrees to 165 degrees. A vibration effect of the motor vibration device is related to a centrifugal force F_{ub} generated by the eccentric in rotation.

A calculation formula for the centrifugal force F_{ub} is: F_{ub}=mr·ω², wherein m is the mass of the eccentric, r is a rotation radius of a centroid of the eccentric, and ω is a rotational angular speed of the eccentric. In the case that the rotational angular speed ω is fixed, the centrifugal force F_{ub} only depends on the parameter mr.

A calculation formula for the mass of the eccentric is m=ρh·½αR², wherein ρ is a density of a material of the eccentric 200, h is a total thickness of the eccentric, and R is a radius of the eccentric 200 (corresponding to the radius of the circular arc edge 228 shown in FIG. 3).

A calculation formula for the radius of the centroid is r=⅔R·\sqrt{2(1−cos α)}/α, where α is an included angle between the first straight edge 225 and the second straight edge 226 shown in FIG. 3. As shown in FIG. 3, since the connection portion 221 has a small volume ratio and a small mass ratio in the eccentric plate 210 and is close to a rotation center of the eccentric plate 210, the eccentric 200 (or the eccentric plate 210) may be simplified as a sector, and the included angle α may be defined as a central angle of the sector.

Therefore,

$$mr = \frac{{R}^{2}}{3} \sqrt{2 ( 1 - cos α )} \cdot ρ h .$$

When the material and the size of the eccentric are determined, the radius R of the eccentric 200, the density ρ of the material of the eccentric 200 and the thickness h of the eccentric 200 are determined, then the value of mr increases as the central angle α approaches 180 degrees. If α is equal to 180 degrees, the centrifugal force F_{ub} reaches the maximal value. In an alternative solution, an ideal effect can be achieved in the case that the central angle α is in a range from 150 degrees to 180 degrees, particularly in a range from 160 degrees to 180 degrees.

The motor vibration device according to the present invention is particularly applicable for a vehicle seat based alert apparatus used to remind a driver of a running state of the vehicle.

The embodiments described above are provided by way of example only, and various other modifications will be apparent to persons skilled in the field without departing from the scope of the invention as defined by the appended claims.

In the description and claims of the present invention, each of the verbs “comprise”, “include”, “contain” and “have”, and variations thereof, are used in an inclusive sense, to specify the presence of the stated item or feature but do not preclude the presence of additional items or features.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

1. A motor vibration device, comprising a motor having a rotating shaft, and an eccentric fixed to the shaft,
wherein the eccentric comprises a plurality of stacked eccentric plates fixed together by engagement of mounting protrusions and mounting recesses formed on adjacent eccentric plates, each of the eccentric plates comprises a connection portion fixed to the shaft and an eccentric portion extending from the connection portion, the connection portion is provided with a through hole for insertion of the shaft, the eccentric portion comprises a first straight edge and a second straight edge respectively extending from two sides of the connection portion and a circular arc edge connecting the first straight edge and the second straight edge, and an included angle between the first straight edge and the second straight edge ranges from 150 degrees to 180 degrees.

2. The motor vibration device of claim 1, wherein in two adjacent eccentric plates, one of the two adjacent eccentric plates has two mounting recesses, and the other one of the two adjacent eccentric plates has two mounting protrusion, and the mounting recesses and the mounting protrusions are configured to fit tightly to fix the two adjacent eccentric plates together.

3. The motor vibration device of claim 2, wherein each of the eccentric plates is stamped to form the mounting recesses on one side and the mounting protrusions on the other side at positions corresponding to the mounting recesses.

4. The motor vibration device of claim 3, wherein each mounting protrusion extends from the respective eccentric portion in a direction perpendicular to the eccentric portion.

5. The motor vibration device of claim 3, wherein each mounting protrusion is approximately in a shape of a truncated pyramid, and comprises a first lateral surface and a second lateral surface perpendicular to the eccentric portion, and the first lateral surface and the second lateral surface are configured to fit tightly with the respective mounting recess.

6. The motor vibration device of claim 3, wherein an outermost eccentric plate of the eccentric does not have a mounting protrusion.

7. The motor vibration device of claim 2, wherein each mounting recess has an opening in a shape of a rectangle, and a longitudinal axis of the opening coincides with a radial direction of the circular arc edge.

8. The motor vibration device of claim 2, wherein an included angle between the two mounting recesses with respect to a center of the through hole is in the range from 90 degrees to 180 degrees.

9. The motor vibration device of claim 2, wherein an included angle between the two mounting recesses with respect to a center of the through hole ranges from 105 degrees to 165 degrees.

10. The motor vibration device of claim 2, wherein an included angle between the two mounting recesses with respect to the center of the through hole is 120 degree.

11. The motor vibration device of claim 1, wherein each mounting protrusion has an extending height that is less than a thickness of the eccentric plate.

12. The motor vibration device of claim 1, wherein the included angle between the first straight edge and the second straight edge ranges from 160 degrees to 180 degrees.

13. The motor vibration device of claim 1, wherein a center of the through hole of the connection portion coincides with a center of the circular arc edge.

14. The motor vibration device of claim 1, wherein each mounting protrusion has a cylindrical shape or semi-spherical shape.

15. The motor vibration device of claim 14, wherein a ratio of the radius of the mounting protrusion to the radius of the circular arc edge ranges from 5% to 35%.

16. The motor vibration device of claim 14, wherein a ratio of the radius of the mounting protrusion to the radius of the circular arc edge is in the range of 15% to 20%.

17. A motor vibration device, comprising:
a motor having a rotating shaft; and
an eccentric fixed to the shaft, the eccentric comprising a plurality of stacked eccentric plates, each of the eccentric plates having a connection portion fixed to the shaft and an eccentric portion extending from the connection portion, the connection portion having a through hole through which the shaft extends,
wherein the plurality of eccentric plates are fixed together by engaging mounting protrusions and mounting recesses formed on adjacent eccentric plates, each eccentric plate has two mounting recesses, and the included angle between the two mounting recesses with respect to the center of the through hole of the connection portion ranges is in the range of 90 degrees to 180 degrees.

18. The motor vibration device of claim 17, wherein the included angle between the two mounting recesses with respect to a center of the through hole is in the range of 105 degrees to 165 degrees.

19. The motor vibration device of claim 17, wherein the included angle between the two mounting recesses with respect to the center of the through hole is 120 degrees.

20. The motor vibration device of claim 17, wherein the mounting protrusion has a cylindrical shape or semi-spherical shape.
